(19) United States
(12) Patent Application Publication
(10) Pub. No.: US 2024/0358184 A1
(43) Pub. Date: Oct. 31, 2024

(54) COFFEE MACHINE AND WATER PATH CONTROL SYSTEM THEREFOR

(71) Applicant: Tsann Kuen (Zhangzhou) Enterprise Co., Ltd., Zhangzhou City (CN)

(72) Inventor: Mengxin HAN, Zhangzhou City (CN)

(21) Appl. No.: 18/424,035

(22) Filed: Jan. 26, 2024

(30) Foreign Application Priority Data
Apr. 28, 2023 (CN) 202321001634.X

(51) Int. Cl. A47J 31/46; A47J 31/44

(52) U.S. Cl. CPC A47J 31/469; A47J 31/4489; A47J 31/461; A47J 31/468

(57) ABSTRACT

The present invention discloses a coffee machine and a water path control system therefor. The water path control system includes a water tank, a water pump, a first changeover valve, a second changeover valve, a heating device and an extraction assembly. The water tank, the water pump and the first changeover valve are sequentially connected. The first changeover valve is sequentially connected with the heating device and the second changeover valve to form a first water path structure. The first changeover valve is connected with the second changeover valve to form a second water path structure. The second changeover valve is connected with the extraction assembly. According to the structure of the present invention, a user can make multiple flavors of coffee with one apparatus within a much shorter time.

### CROSS-REFERENCE TO RELATED APPLICATIONS

This application claims priority to Chinese Patent Application 202321001634.X, filed on Apr. 28, 2023, which is incorporated herein by reference.

### TECHNICAL FIELD

The present invention relates to a coffee machine, and in particular to a water path control system for a coffee machine.

### BACKGROUND

At present, the existing coffee extraction methods are roughly divided into two types. One type uses hot water, which usually uses a high-pressure coffee machine to extract espresso or use a drip coffee machine to brew coffee. The other type uses cold water or room temperature water, which usually soaks ground coffee in low temperature water. This process takes about 8 to 12 h or even longer.

The existing coffee extraction with cold water takes a long time. Moreover, if the user wants to taste different flavors of coffee extracted by different methods, it is required to prepare multiple sets of coffee extraction devices.

### SUMMARY

An objective of the present invention is to provide a coffee machine and a water path control system therefor that can improve at least one defect in the prior art.

The present invention discloses a water path control system for a coffee machine, including a water tank, a water pump, a first changeover valve, a second changeover valve, a heating device and an extraction assembly. The water tank, the water pump and the first changeover valve are sequentially connected. The first changeover valve is sequentially connected with the heating device and the second changeover valve to form a first water path structure. The first changeover valve is connected with the second changeover valve to form a second water path structure. The second changeover valve is connected with the extraction assembly.

According to the water path control system for a coffee machine of the present invention, when the water pump draws a liquid in the water tank through the first water path structure to the extraction assembly while continuously pressurizing the liquid, an output pressure of the water pump is a first pressure value, and is kept stable until extraction is completed.

According to the water path control system for a coffee machine of the present invention, when the water pump draws a liquid in the water tank through the second water path structure to the extraction assembly while continuously pressurizing the liquid, an output pressure of the water pump is a first pressure value, and is kept stable until extraction is completed.

According to the water path control system for a coffee machine of the present invention, the first pressure value is 6 bar to 10 bar.

According to the water path control system for a coffee machine of the present invention, when the water pump draws a liquid in the water tank through the second water path structure to the extraction assembly, the water pump draws the liquid in the water tank while intermittently pressurizing the liquid, and an output pressure of the water pump when drawing the liquid while pressurizing the liquid is a second pressure value.

According to the water path control system for a coffee machine of the present invention, the second pressure value 1 bar to 6 bar.

The water path control system for a coffee machine of the present invention further includes a pressure relief member connected and arranged between the water pump and the first changeover valve. The pressure relief member is connected to the water tank and makes the pressure-relieved water flow back to the water tank.

The water path control system for a coffee machine of the present invention further includes a flow controller connected and arranged between the water tank and the water pump.

The water path control system for a coffee machine of the present invention further includes a steam assembly connected with the second changeover valve.

The present invention further discloses a coffee machine, including the water path control system for a coffee machine.

The present invention has the following beneficial effects: A user can make multiple flavors of coffee with one apparatus, and can make cold brew coffee within a much shorter time than a traditional cold extraction method by soaking.

### BRIEF DESCRIPTION OF DRAWINGS

FIG. 1 is a connection diagram of water paths of a water path control system for a coffee machine according to the present invention;

FIG. 2 is a chart showing changes of water pressure in a water tube of the water path control system when a water pump continuously pressurizes a liquid to output a first pressure value in a case of making hot brew coffee;

FIG. 3 is a chart showing changes of water pressure in the water tube of the water path control system when the water pump continuously pressurizes the liquid to output the first pressure value in a case of making cold brew coffee; and

FIG. 4 is a chart showing changes of water pressure in the water tube of the water path control system when the water pump works while intermittently pressurizing the liquid in a case of making cold brew coffee.

### DESCRIPTION OF EMBODIMENTS

The present invention will be further described with reference to the following embodiments, but it should be understood that the embodiments are for illustrative purposes only and should not be construed as a limitation on the implementation of the present invention, and that similar components are denoted by the same number.

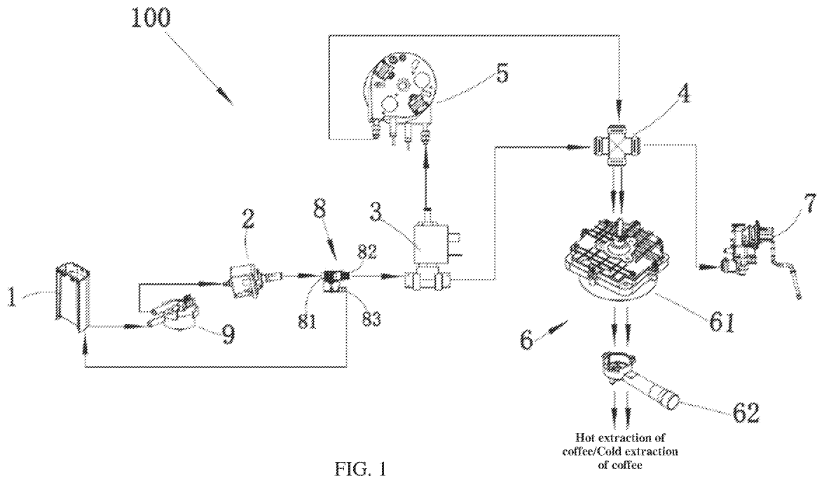

With reference to FIG. 1, a water path control system 100 for a coffee machine includes a water tank 1, a water pump 2, a first changeover valve 3, a second changeover valve 4, a heating device 5 and an extraction assembly 6. The water tank 1, the water pump 2 and the first changeover valve 3 are sequentially connected. The first changeover valve 3 is sequentially connected with the heating device 5 and the second changeover valve 4 to form a first water path structure. The first changeover valve 3 is connected with the second changeover valve 4 to form a second water path structure, and the second changeover valve 4 is connected with the extraction assembly 6.

The water path control system 100 for a coffee machine can make hot brew coffee and cold brew coffee. In a case of making hot brew coffee, the water pump 2 draws a liquid in the water tank 1 through the first water path structure into the extraction assembly 6. The detailed process is as follows: The water pump 2 pressurizes the liquid in the water tank 1 and pumps the liquid to the first changeover valve 3; at this time, a port of the first changeover valve 3 to the first water path structure is opened, and a port to the second water path structure is closed; and after flowing through the heating device 5 and being heated to a certain temperature, the liquid enters the extraction assembly 6 through the second changeover valve 4 so as to make the hot brew coffee. The extraction assembly 6 here is a device including a coffee extraction drip tray 61 and a portafilter 62, which will not be described in detail here.

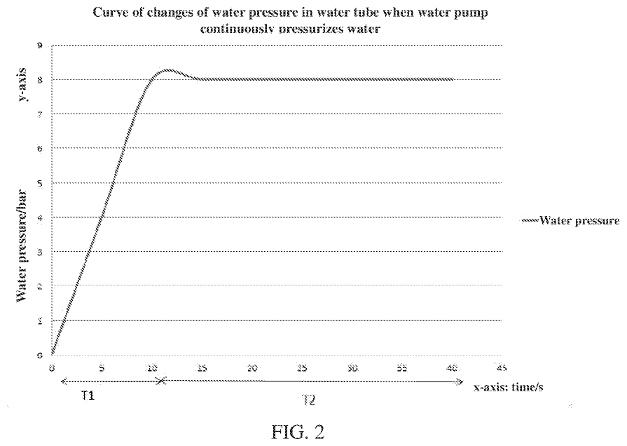

When the water pump 2 draws the liquid in the water tank 1 through the first water path structure to make hot brew coffee, in a preferred embodiment, the water pump 2 needs to continuously output a pressure with a pressure value of a first pressure value and keeps the pressure stable until extraction is completed. The first pressure value is preferably 6 bar to 10 bar. Changes of the pressure value of water in the water path structure when the water pump continuously pressurizes the liquid in a case of making a cup of hot brew coffee will be described with reference to FIG. 2. The x-axis represents time, and the y-axis represents the water pressure. When a user makes hot brew coffee, the water pump pressurizes water from 0 bar to the first pressure value within time T1. The first pressure value shown in FIG. 2 is 8 bar. After time T1, the water pump draws water while continuously pressurizing the water such that the output pressure is kept at the first pressure value. As shown in FIG. 2, within time T2, the water pressure is stabilized at 8 bar until the extraction is completed. In actual operations, the first pressure value to which the water pump pressurizes the water may fluctuate within time T2, but may not exceed the range of the first pressure value. According to this preferred embodiment, hot brew espresso, i.e., espresso can be made.

In a case of making cold brew coffee, the water pump 2 draws the liquid in the water tank 1 through the second water path structure into the extraction assembly 6. The detailed process is as follows: The water pump 2 pumps the liquid in the water tank 1 to the first changeover valve 3; at this time, a port of the first changeover valve 3 to the first water path structure is closed, and a port to the second water path structure is opened; and the liquid flows from the first changeover valve 3 to the second changeover valve 4 and then enters the extraction assembly 6 so as to make the cold brew coffee. In the case of making cold brew coffee, the liquid in the water tank 1 may be cold water or room temperature water.

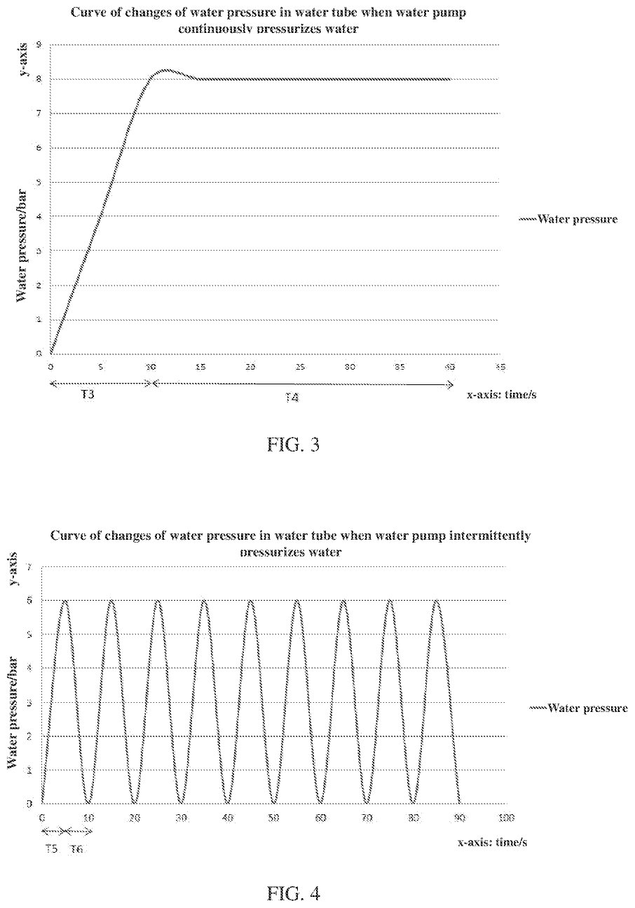

When the water pump 2 draws the liquid in the water tank 1 through the second water path structure to make cold brew coffee, in a preferred embodiment, the water pump 2 needs to continuously output a pressure with a pressure value of a first pressure value and keeps the pressure stable until extraction is completed. The first pressure value is preferably 6 bar to 10 bar. Changes of the pressure value of water in the water path structure when the water pump continuously pressurizes the liquid in a case of making a cup of cold brew coffee will be described with reference to FIG. 3. The x-axis represents time, and the y-axis represents the water pressure. When the user makes cold brew coffee, the water pump pressurizes water from 0 bar to the first pressure value within time T3. The first pressure value shown in FIG. 3 is 8 bar. After time T3, the water pump draws water while continuously pressurizing the water such that the output pressure is kept at the first pressure value. As shown in FIG. 3, within time T4, the water pressure is stabilized at 8 bar until the extraction is completed. In actual operations, the first pressure value to which the water pump pressurizes the water may fluctuate within time T4, but may not exceed the range of the first pressure value. According to this preferred embodiment, cold brew espresso can be made within 10 s to 50 s. This process can greatly shorten the time for making cold brew coffee.

When the water pump 2 draws the liquid in the water tank 1 through the second water path structure to make cold brew coffee, in a preferred embodiment, the water pump 2 needs to draw the liquid in the water tank 1 while intermittently pressurizing the liquid. When the water pump 2 draws the liquid while pressurizing the liquid, it outputs a pressure with a pressure value of a second pressure value. After a preset time of extraction according to the process in which the water pump 2 draws water in the water tank while intermittently pressurizing the water, the cold brew coffee can be made. The second pressure value is preferably 1 bar to 6 bar. Changes of the water pressure in the water path structure when the water pump intermittently pressurizes the liquid in a case of making a cup of cold brew coffee will be described with reference to FIG. 4. The x-axis represents time, and the y-axis represents the water pressure. When the user makes cold brew coffee, the water pump 2 draws water while continuously pressurizing the water within time T5 such that the water is pressurized from 0 bar to the second pressure value. The second pressure value shown in FIG. 4 is 6 bar. If time T5 is relatively long, the water pump will continuously output a pressure with a pressure value of the second pressure value such that the pressure of the water is kept at the second pressure value until the end of T5. Within time T6, the water pump only draws water but does not output pressure. As shown in FIG. 4, the pressure of the water will quickly drop within time T6. This water drawing process is repeated to a predetermined time, thereby making the cold brew coffee. According to this preferred embodiment, cold brew Americano can be made within 60 s to 120 s. This process can greatly shorten the time for making cold brew coffee.

In a preferred embodiment, the first changeover valve 3 is a three-way solenoid valve, and the second changeover valve 4 is a four-way pipe.

With reference to FIG. 1, in a preferred embodiment, a pressure relief member 8 is arranged and connected between the water pump 2 and the first changeover valve 3. A water inlet 81 of the pressure relief member 8 is connected with a water outlet of the water pump 2. A first water outlet 82 of the pressure relief member 8 is connected with the first changeover valve 3, and a second water outlet 83 is connected with the water tank 1. During the pressure relief process, water flows from the second water outlet 83 of the pressure relief member 8 to the water tank 1. This structure can recycle water, and there is no need to additionally provide a drain tray.

With reference to FIG. 1, in a preferred embodiment, a flow controller 9 is connected and arranged between the water pump 2 and the water tank 1, and configured to detect a flow of the liquid in the tube or indicate a total amount of the liquid within a preset time interval, which is the technology known by those skilled in the art and will not be described in detail here.

With reference to FIG. 1, in a preferred embodiment, the water path control system 100 for a coffee machine further includes a steam assembly 7 connected with the second changeover valve 4. The steam assembly 7 is a common device for providing hot water or steam, and will not be described in detail here.

The present invention further provides a coffee machine, including the water path control system 100 for a coffee machine

The water path control system 100 for a coffee machine and the coffee machine can make hot brew coffee and cold brew coffee, and can make different flavors of coffee in a short time. Therefore, the objective of the present invention can be achieved.

The above is only the embodiments of the present invention, when cannot be used to limit the scope of implementation of the present invention. All simple equivalent changes and modifications made according to the claims and the Description of the present invention shall fall within the scope of the present invention.

1. A water path control system for a coffee machine, comprising a water tank, a water pump, a first changeover valve, a second changeover valve, a heating device and an extraction assembly, wherein the water tank, the water pump and the first changeover valve are sequentially connected, the first changeover valve is sequentially connected with the heating device and the second changeover valve to form a first water path structure, the first changeover valve is connected with the second changeover valve to form a second water path structure, and the second changeover valve is connected with the extraction assembly.

2. The water path control system for a coffee machine according to claim 1, wherein when the water pump draws a liquid in the water tank through the first water path structure to the extraction assembly while continuously pressurizing the liquid, an output pressure of the water pump is a first pressure value, and the output pressure is kept stable until extraction is completed.

3. The water path control system for a coffee machine according to claim 2, wherein the first pressure value is 6 bar to 10 bar.

4. The water path control system for a coffee machine according to claim 1, wherein when the water pump draws a liquid in the water tank through the second water path structure to the extraction assembly while continuously pressurizing the liquid, an output pressure of the water pump is a first pressure value, and the output pressure is kept stable until extraction is completed.

5. The water path control system for a coffee machine according to claim 4, wherein the first pressure value is 6 bar to 10 bar.

6. The water path control system for a coffee machine according to claim 1, wherein when the water pump draws a liquid in the water tank through the second water path structure to the extraction assembly, the water pump draws the liquid in the water tank while intermittently pressurizing the liquid, and an output pressure of the water pump when drawing the liquid while pressurizing the liquid is a second pressure value.

7. The water path control system for a coffee machine according to claim 6, wherein the second pressure value is 1 bar to 6 bar.

8. The water path control system for a coffee machine according to claim 1, further comprising a pressure relief member connected and arranged between the water pump and the first changeover valve, wherein the pressure relief member is connected to the water tank and makes pressure-relieved water flow back to the water tank.

9. The water path control system for a coffee machine according to claim 1, further comprising a flow controller connected and arranged between the water tank and the water pump.

10. The water path control system for a coffee machine according to claim 1, further comprising a steam assembly connected with the second changeover valve.

11. A coffee machine, comprising the water path control system for a coffee machine according to claim 1.

12. The coffee machine according to claim 11, wherein when the water pump draws a liquid in the water tank through the first water path structure to the extraction assembly while continuously pressurizing the liquid, an output pressure of the water pump is a first pressure value, and the output pressure is kept stable until extraction is completed.

13. The coffee machine according to claim 12, wherein the first pressure value is 6 bar to 10 bar.

14. The coffee machine according to claim 11, wherein when the water pump draws a liquid in the water tank through the second water path structure to the extraction assembly while continuously pressurizing the liquid, an output pressure of the water pump is a first pressure value, and the output pressure is kept stable until extraction is completed.

15. The coffee machine according to claim 14, wherein the first pressure value is 6 bar to 10 bar.

16. The coffee machine according to claim 11, wherein when the water pump draws a liquid in the water tank through the second water path structure to the extraction assembly, the water pump draws the liquid in the water tank while intermittently pressurizing the liquid, and an output pressure of the water pump when drawing the liquid while pressurizing the liquid is a second pressure value.

17. The coffee machine according to claim 16, wherein the second pressure value is 1 bar to 6 bar.

18. The coffee machine according to claim 11, further comprising a pressure relief member connected and arranged between the water pump and the first changeover valve, wherein the pressure relief member is connected to the water tank and makes pressure-relieved water flow back to the water tank.

19. The coffee machine according to claim 11, further comprising a flow controller connected and arranged between the water tank and the water pump.

20. The coffee machine according to claim 11, further comprising a steam assembly connected with the second changeover valve.
